(19) United States
(12) Patent Application Publication
(10) Pub. No.: US 2010/0198527 A1
(43) Pub. Date: Aug. 5, 2010

(54) SYSTEM AND METHOD FOR ESTIMATING AT LEAST ONE CHARACTERISTIC OF A MOTOR VEHICLE SUSPENSION

(75) Inventors: Pascal Gouriet, Chatillon (FR); Karine Candau, Clamart (FR)

Correspondence Address: NICOLAS E. SECKEL;Patent Attorney, 1250 Connecticut Avenue, NW Suite 700, WASHINGTON, DC, 20036, US

(73) Assignee: PEUGEOT CITROEN AUTOMOBILES SA, Velizy Villacoublay (FR)

(21) Appl. No.: 12/063,852

(22) PCT Filed: Jul. 26, 2006
(86) PCT No.: PCT/FR06/50752

§ 371 Date: Mar. 20, 2008

(30) Foreign Application Priority Data
Aug. 10, 2005 (FR) 0508494

(51) Int. Cl. G01M 17/04; G06F 19/00

(52) U.S. Cl. 702/33; 73/117.03

(57) ABSTRACT

The invention relates to a system for estimating at least one characteristic of a motor vehicle suspension, whereby said suspension or each suspension connects a motor vehicle wheel to the body shell thereof. The inventive system comprises means (12, 14) for acquiring vertical accelerations experienced by the wheel and body shell in a reference system of the vehicle and means (26) for calculating the at least one characteristic of the suspension as a function of the vertical accelerations acquired from the wheel and the body shell.

The present invention concerns a method and a system for estimating at least one characteristic of a suspension connecting a motor vehicle wheel to the body of this vehicle.

The characteristics of a suspension connecting a motor vehicle wheel to the body of this vehicle are magnitudes that influence the directional stability of the vehicle and the effectiveness of wheel anti-blocking and vehicle trajectory control systems.

Systems for estimating certain characteristics of the suspension are known. Typically, these systems comprise sensors that measure directly the clearance and means for estimating the clearance variation speed, the vehicle mass, and the coefficient of stiffness and damping coefficient of the suspension.

Such systems use maps to estimate these characteristics. These maps are determined at the factory for a group of vehicles of the same category.

In practice, these systems have shown little robustness to variations in the operation of the suspension, such as the worn state of the shock absorbers. In addition, the precision of these systems can be unsatisfactory.

The objective of the present invention is to remedy the above-mentioned problem by proposing a system that estimates characteristics of the suspension with precision and robustness regarding the operating state of this suspension.

To this effect, an object of the invention is a system for estimating at least one characteristic of at least one motor vehicle suspension, the or each suspension connecting a motor vehicle wheel to the body of this vehicle, characterized in that it comprises means for acquiring the vertical accelerations of the wheel and of the body in a referential of the vehicle and means for calculating the at least one characteristic of the suspension as a function of the acquired vertical accelerations of the wheel and of the body.

According to particular embodiments, the invention includes one or more of the following characteristics:
each of the at least one characteristic is selected from the group consisting of the clearance of the suspension, the clearance variation speed of the suspension, the coefficient of stiffness of the suspension, the damping coefficient of the suspension, the spring force of the suspension, and the damping force of the suspension;
the means for calculating the at least one characteristic are adapted to calculate this at least one characteristic based on a mono-wheel mechanical model of the wheel connected to the body thereof by means of the suspension;
the calculation means comprise means forming Kalman estimator adapted to estimate the at least one characteristic from the mono-wheel mechanical model;
the means forming Kalman estimator are adapted to implement an extended Kalman estimator of the state vector

$${( \begin{matrix}{z}_{1} & {z}_{2} & {z}_{3} & {z}_{4}\end{matrix} )}^{T} = {( \begin{matrix}deb & Vdeb & \frac{{K}_{c}}{{m}_{c}} & \frac{{R}_{c}}{{m}_{c}}\end{matrix} )}^{T} ,$$

where zᵢ, i−1, . . . , 4, is a state variable, deb is the clearance, Vdeb is the clearance variation speed, m_{c} is the mass of the vehicle body adjusted to the wheel, K_{c} is the coefficient of stiffness of the suspension, and R_{c} is the damping coefficient of the suspension;
the means forming Kalman estimator are adapted to estimate the state vector (x₁×₂)^{T}=(deb Vdeb)^{T}, where deb is the clearance of the suspension and Vdeb is the clearance variation speed of the suspension;
it further comprises means for acquiring longitudinal and lateral accelerations of the body, and in that the means for calculating the at least one characteristic are adapted to calculate this at least one characteristic based on a mono-wheel mechanical model of the wheel taking into account load transfers in the area of the wheel;
the means for acquiring the vertical accelerations of the wheel and of the body comprise an accelerometer arranged in the body in vertical alignment with the wheel;
the vehicle is equipped with four suspensions connecting four wheels to the body of this vehicle, and it comprises, associated with each group composed of a suspension connecting a wheel to the body of the vehicle, accelerometers to measure the vertical accelerations of the wheel and of the body.

Another object of the invention is a method of estimating at least one characteristic of a motor vehicle suspension, the or each suspension connecting a motor vehicle wheel to the body of this vehicle, characterized in that it comprises a step of acquiring the vertical accelerations of the wheel and of the body in a referential of the vehicle, and a step of calculating the at least one characteristic of the suspension as a function of the acquired vertical accelerations of the wheel and of the body.

The invention will be better understood by reading the following description, which is given by way of example only, in reference to the annexed drawings in which:

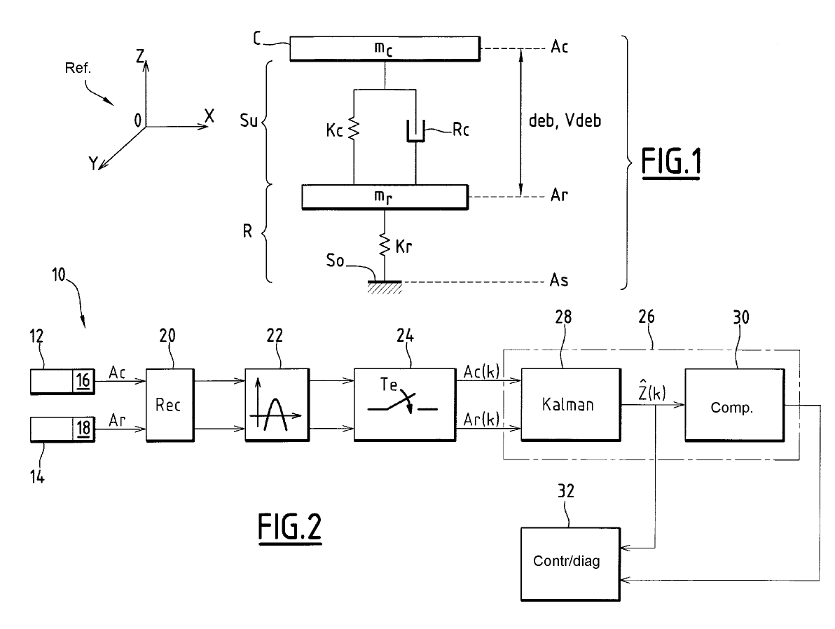

FIG. 1 is a mechanical model of a motor vehicle wheel connected to the body of this vehicle by a suspension;

FIG. 2 is a schematic view of a system according to the invention;

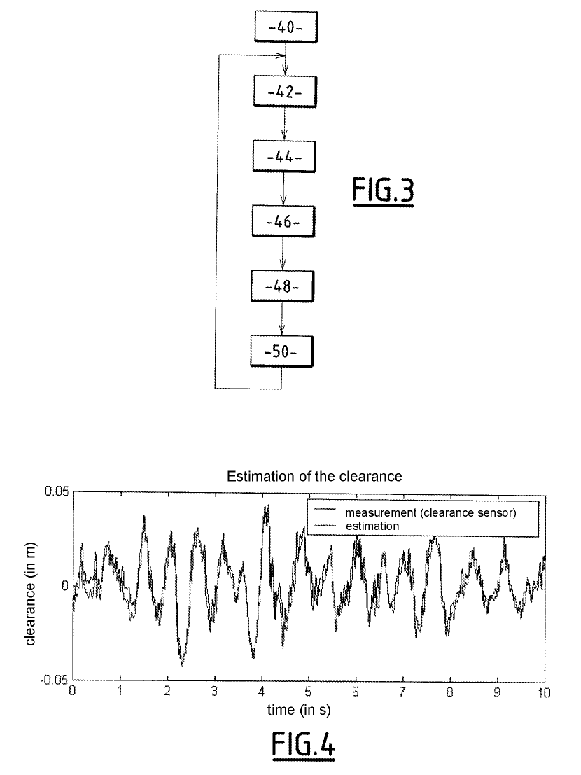

FIG. 3 is a flow chart of the method implemented by the system of FIG. 2;

FIG. 4 is a graph on which are traced, as a function of time, the clearance estimated by the system of FIG. 2 and the clearance estimated by a sensor;

FIG. 5 is a graph on which are traced, as a function of time, the clearance variation speed estimated by the system of FIG. 2 and the derivative of the clearance measured by a sensor; and

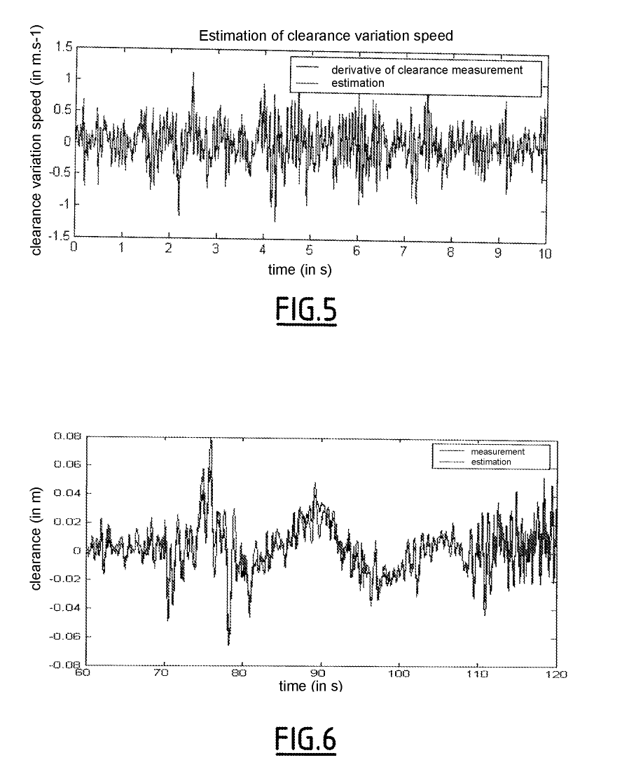

FIG. 6 is a graph on which are traced, as a function of time, the clearance estimated by the system of FIG. 2, taking into account the load transfer to the wheel of the vehicle and the clearance measured by a sensor.

FIG. 1 illustrates a mono-wheel mechanical model of a wheel R of a motor vehicle having four wheels, connected to the body C of this vehicle by means of a suspension Su, the wheel R being in contact with the ground So.

In this model, the body C has a mass at the wheel m_{c}. The suspension Su is modeled by a spring having a coefficient of stiffness K_{c} in parallel with a shock absorber having a damping coefficient R_{c}. Lastly, the wheel R has a mass mᵣ and the tire of this wheel is modeled by a spring having a coefficient of stiffness Kᵣ.

The distance between the wheel R and the body C is called clearance.

Using the fundamental principle of dynamics, it can be shown that the mono-wheel mechanical model of FIG. 1 satisfies the following equations:

$$\{ \begin{matrix}\dot{z} ( t ) = [ \begin{matrix}{z}_{2} ( t ) \\ - {z}_{3} ( t ) {z}_{1} ( t ) - {z}_{4} ( t ) {z}_{2} ( t ) \\ 0 \\ 0\end{matrix} ] + [ \begin{matrix}0 \\ 1 \\ 0 \\ 0\end{matrix} ] {A}_{r} ( t ) \\ {A}_{c} ( t ) = [ {z}_{3} ( t ) {z}_{1} ( t ) + {z}_{4} ( t ) {z}_{2} ( t ) ]\end{matrix} \\ with \\ z ( t ) = [ \begin{matrix}deb ( t ) \\ Vdeb ( t ) \\ \frac{{K}_{c}}{{m}_{c}} ( t ) \\ \frac{{R}_{c}}{{m}_{c}} ( t )\end{matrix} ] = [ \begin{matrix}{z}_{1} ( t ) \\ {z}_{2} ( t ) \\ {z}_{3} ( t ) \\ {z}_{4} ( t )\end{matrix} ] \qquad ( 1 )$$

where t is time, deb is the clearance, Vdeb is the clearance variation speed, and Aᵣ and A_{c} are vertical accelerations of the wheel and of the body, respectively, i.e., the accelerations of the wheels and of the body along the axis Oz of a referential Ref of the motor vehicle.

The above model represents well the transmission of the solicitations by the ground through the suspension up to the body, but it does not take load transfers into account. That is, the vertical load supported by the suspension varies when the vehicle is turning, braking, and accelerating. For example, when braking, the front suspension supports an additional vertical load and the rear suspension is relieved of this same load. This is called a load transfer from the rear to the front during braking, and this load transfer generates an additional force that applies to the body and triggers a low frequency movement of the body.

The force due to the load transfers is defined as a function of the lateral and longitudinal accelerations of the body of the vehicle according to the equation Transfert=αA_{longi}+βAₗₐₜ, where α and β are predetermined load transfer coefficients, A_{longi} is the longitudinal acceleration of the body, and Aₗₐₜ is the lateral acceleration of the body.

To take into account the solicitations in the area of the ground and the solicitations in the area of the body due to the load transfers when turning, braking or accelerating, the state representation according to the equations (1) are redefined as follows:

$$\{ \begin{matrix}\dot{z} ( t ) = [ \begin{matrix}{z}_{2} ( t ) \\ - {z}_{3} ( t ) {z}_{1} ( t ) - {z}_{4} ( t ) {z}_{2} ( t ) \\ 0 \\ 0\end{matrix} ] + [ \begin{matrix}0 & 0 & 0 \\ 1 & - α & - β \\ 0 & 0 & 0 \\ 0 & 0 & 0\end{matrix} ] ( \begin{matrix}{A}_{r} ( t ) \\ {A}_{longi} ( t ) \\ {A}_{lat} ( t )\end{matrix} ) \\ {A}_{c} ( t ) = [ {z}_{3} ( t ) {z}_{1} ( t ) + {z}_{4} ( t ) {z}_{2} ( t ) ] + [ 0 α β ] ( \begin{matrix}{A}_{r} ( t ) \\ {A}_{longi} ( t ) \\ {A}_{lat} ( t )\end{matrix} )\end{matrix} \qquad ( 2 )$$

The coefficients α and β are determined according to the equations:

$$- α = - \frac{2 h}{E - a} and β = \frac{2 h}{v}$$

for the left front wheel of the vehicle,

$$- α = - \frac{2 h}{E - a} and β = - \frac{2 h}{v}$$

for the right front wheel of the vehicle,

$$- α = \frac{2 h}{a} and β = - \frac{2 h}{v}$$

for the right rear wheel of the vehicle,

$$- α = \frac{2 h}{a} and β = \frac{2 h}{v}$$

for the left front wheel of the vehicle,

where E is the wheel base of the vehicle, v is the wheel track of the vehicle, h is the height of the center of gravity of the vehicle, and a is the position of the center of gravity with respect to the middle of the front axle of the vehicle.

We will now describe, with reference to FIG. 2, first embodiment of a system for estimating the characteristics of a motor vehicle suspension connecting a wheel to the body of this vehicle, based on the mono-wheel model of state representation according to the equations (1), and more particularly on a discretization of the state representation.

This system is designated by the general reference 10 and includes an mono-axis accelerometer 12 arranged in the area of the center of the wheel and measuring the vertical acceleration Aᵣ of this wheel.

The system 10 also comprises a mono-axis accelerometer 14 arranged in the body of the vehicle in vertical alignment with the wheel and measuring the vertical acceleration A_{c} of the body.

Each of the accelerometers 12, 14 comprises means 16, 18 forming emitting antenna for supplying an electromagnetic signal representing the vertical acceleration Aᵣ, A_{c} that it measures.

Means 20 forming receiving antenna are provided in the system 10 to receive the signals emitted by the accelerometers 12, 14 and to extract from these signals the accelerations Aᵣ, A_{c} measured by these accelerometers.

The means 20 are connected to a low-pass filter 22 adapted to process the accelerations Aᵣ, A_{c} of the wheel and of the body supplied by the means 20 by filtering out the high frequency noises using the low-pass filter. The filtering operation on the accelerations is carried out, for example, in a frequency range substantially equal to the range [0; 50] Hz.

As a variant, the low-pass filter 22 is omitted.

The low-pass filter 22 is further connected to an analog/digital converter 24, for example, a zero-order sample and hold circuit, adapted to digitalize the filtered accelerations with a predetermined sampling period T, for example, comprised between about 50 Hz and 1000 Hz, and thus, to supply as output digital accelerations Aᵣ(k), A_{c}(k) of the wheel and of the body, where k represents the k^{th} sampling instant.

The sampling circuit 24 is connected to a computing unit 26 that estimates the state vector z as a function of the digital accelerations Aᵣ(k), A_{c}(k) from the state representation according to the equations (1) discretized according to the period T.

More particularly, the computing unit 26 comprises a module 28 implementing an extended Kalman estimator of the state vector z according to the equations:

$$\begin{matrix}{\hat{z}}^{-} ( k ) = ( \begin{matrix}1 & T & 0 & 0 \\ - {\hat{z}}_{3} ( k - 1 ) * T & 1 - {\hat{z}}_{4} ( k - 1 ) * T & 0 & 0 \\ 0 & 0 & 1 & 0 \\ 0 & 0 & 0 & 1\end{matrix} ) \hat{z} ( k - 1 ) + ( \begin{matrix}0 \\ T \\ 0 \\ 0\end{matrix} ) {A}_{r} ( k - 1 ) & ( 3 ) \\ A ( k ) = ( \begin{matrix}1 & T & 0 & 0 \\ - {\hat{z}}_{3} ( k - 1 ) * T & 1 - {\hat{z}}_{4} ( k - 1 ) * T & - {\hat{z}}_{1} ( k - 1 ) * T & - {\hat{z}}_{2} ( k - 1 ) * T \\ 0 & 0 & 1 & 0 \\ 0 & 0 & 0 & 1\end{matrix} ) & ( 4 ) \\ B ( k ) = ( \begin{matrix}0 & T & 0 & 0\end{matrix} ) & ( 5 ) \\ {P}^{-} ( k ) = A ( k ) \cdot P ( k - 1 ) \cdot {A}^{T} ( k ) + B ( k ) \cdot Q ( k ) \cdot {B}^{T} ( k ) + {Q}_{0} ( k ) & ( 6 ) \\ h ( {\hat{z}}^{-} ( k ) ) = ( {\hat{z}}_{3} ( k ) {\hat{z}}_{4} ( k ) 0 \; 0 ) {\hat{z}}^{-} ( k ) & ( 7 ) \\ C ( k ) = ( \begin{matrix}{\hat{z}}_{3}^{-} ( k ) & {\hat{z}}_{4}^{-} ( k ) & {\hat{z}}_{1}^{-} ( k ) & {\hat{z}}_{2}^{-} ( k )\end{matrix} ) & ( 8 ) \\ K ( k ) = {P}^{-} ( k ) \cdot {C}^{T} ( k ) \cdot {( C ( k ) \cdot {P}^{-} ( k ) \cdot {C}^{T} ( k ) + R ( k ) )}^{- 1} & ( 9 ) \\ P ( k ) = ( I - K ( k ) \cdot C ( k ) ) {P}^{-} ( k ) & ( 10 ) \\ \hat{z} ( k ) = {\hat{z}}^{-} ( k ) + K ( k ) \cdot ( {A}_{c} ( k ) - h ( {\hat{z}}^{-} ( k ) ) ) & ( 11 )\end{matrix}$$

where \hat{z}⁻(k)=(\hat{z}(k) \hat{z}₂⁻(k) \hat{z}₃⁻(k) \hat{z}₄⁻(k))^{T} is the prediction of the state vector z at instant k, \hat{z}(k)=(\hat{z}₁(k) \hat{z}₂(k) \hat{z}₃(k) \hat{z}z₄ (k))^{T} is the estimation of the state vector z at instant k, P (k) is the prediction of the covariance of the estimation error at instant k, P(k) is the estimation of the error covariance at instant k, K(k) is the Kalman gain at instant k, Q₀ is the covariance of the state noise, Q is the covariance of the measurement noise of the vertical acceleration of the wheel, and R is the covariance of the measurement noise of the vertical acceleration of the body.

The covariances Q and R are supplied, for example, by the manufacturers of the accelerometers 12, 14, or they are determined in a previous statistical study, also performed to determine the covariance Q₀.

The Kalman estimator begins, for example, by the prediction of the vector z during startup of the vehicle by selecting, for the initial value of the state vector z, a value of the clearance of the vehicle at rest memorized in the module 28 and determined during the previous study, or a clearance value of zero, a clearance variation speed of zero, the last estimations of the coefficient of stiffness and of the damping coefficient of the suspension determined during the last implementation of the Kalman estimator, or the values of these coefficients given by the manufacturer of the suspension if the Kalman estimator is implemented for the first time.

The unit 26 also comprises a computing module 30 connected to the estimation module 28 and adapted to calculate at each sampling instant k:
an estimation \hat{K}_{c}(k) of the coefficient of stiffness of the suspension by multiplying the estimation

$${\hat{z}}_{3} ( k ) = \frac{{\hat{K}}_{c}}{{m}_{c}} ( k )$$

of the third variable of the state vector z by the mass m_{c} of the body adjusted to the wheel;
an estimation \hat{R}_{c}(k) of the damping coefficient of the suspension by multiplying the estimation

$${\hat{z}}_{4} ( k ) = \frac{{\hat{R}}_{c}}{{m}_{c}}$$

of the fourth variable of the state vector z by the mass m_{c} of the body adjusted to the wheel;
an estimation \hat{F}_{spring} (k) of the spring force of the suspension by multiplying the estimation \hat{z}₁(k)=dêb(k) of the first variable of the state vector z by the estimation \hat{K}_{c}(k) of the coefficient of stiffness of the suspension; and
an estimation \hat{F}_{damp}(k) of the damping force of the suspension by multiplying the estimation \hat{z}₁(k)=V\hat{d}eb(k) of the second variable of the state vector z by the estimation \hat{R}_{c}(k) of the damping coefficient of the suspension.

Lastly, the unit 26 is connected to a control and diagnostic unit 32 adapted to control the operation of the vehicle and to diagnose the operating state of the suspension as a function of the estimations \hat{z}₁(k)=dêb(k), \hat{z}₂(k)=V\hat{d}eb(k), \hat{K}_{c}(k), \hat{R}_{c}(k), \hat{F}_{spring}(k) and \hat{F}_{damp}(k) calculated by the estimation and computing modules 28, 30.

We will now describe, still in reference to FIG. 2, a second embodiment of the system according to the invention based on the mono-wheel model of state representation according to equations (2), and more particularly a discretization of this representation according to the sampling period T.

This embodiment is structurally analogous to the first embodiment which is described above. In the second embodiment, the accelerometer 14 is a tri-axis accelerometer measuring the vertical A_{c}, longitudinal A_{longi}, and lateral Aₗₐₜ accelerations of the body, i.e., measuring the accelerations of the body according to axes OZ, OY, and OY of the referential Ref of the vehicle.

The measurements of these accelerations are emitted by the means 16, 18 forming emitting antenna of the accelerometers 12 and 14, received by the means 20 forming receiving antenna, then filtered and sampled by the filter 22 and sampler 24. The digital accelerations A_{c}(k), A_{longi}(i), Aₗₐₜ(k) of the body, and the digital accelerator Aᵣ(k) of the wheel are then supplied to the estimation module 28.

The module 28 implements, as a function of these values, an extended Kalman estimator of the state vector z analogous to that described above, in which the equations (3), (4), (5), and (7) are replaced by the following equations (12), (13), (14), and (15), respectively:

$$\begin{matrix}{z}^{-} ( k ) = [ \begin{matrix}1 & T & 0 & 0 \\ - {\hat{z}}_{3} ( k - 1 ) * T & 1 - {\hat{z}}_{4} ( k - 1 ) * T & 0 & 0 \\ 0 & 0 & 1 & 0 \\ 0 & 0 & 0 & 1\end{matrix} ] \hat{z} ( k - 1 ) + [ \begin{matrix}0 & 0 & 0 \\ T & - α T & - β T \\ 0 & 0 & 0 \\ 0 & 0 & 0\end{matrix} ] ( \begin{matrix}{A}_{r} ( k ) \\ {A}_{longi } ( k ) \\ {A}_{lat} ( k )\end{matrix} ) & ( 12 ) \\ A ( k ) = \\ [ \begin{matrix}1 & T & 0 & 0 \\ - {\hat{z}}_{3} ( k - 1 ) * T & 1 - {\hat{z}}_{4} ( k - 1 ) * T & - {\hat{z}}_{1} ( k - 1 ) * T & - {\hat{z}}_{2} ( k - 1 ) * T \\ 0 & 0 & 1 & 0 \\ 0 & 0 & 0 & 1\end{matrix} ] & ( 13 ) \\ B ( k ) = [ \begin{matrix}0 & 0 & 0 \\ T & - α T & - β T \\ 0 & 0 & 0 \\ 0 & 0 & 0\end{matrix} ] & ( 14 ) \\ h ( {\hat{z}}^{-} ( k ) ) = [ {\hat{z}}_{3} ( k ) {\hat{z}}_{4} ( k ) 0 \; 0 ] {\hat{z}}^{-} ( k ) + [ 0 α β ] ( \begin{matrix}{A}_{r} ( k ) \\ {A}_{longi } ( k ) \\ {A}_{lat} ( k )\end{matrix} ) & ( 15 )\end{matrix}$$

Lastly, the module 30 calculates the estimations \hat{K}_{c}(k), \hat{R}_{c}(k), \hat{F}_{spring}(k) and \hat{F}_{damp} (k) in the above-described manner.

FIG. 4 is a flow chart of the method according to the invention implemented by the system of FIG. 2.

In a first initialization step 40, the various parameters required for the estimation of the state vector z by extended Kalman estimation, i.e., the covariances Q, R, Q₀ and the initial value of the state vector z are determined.

In a subsequent step 42, the digital measurements Aᵣ(k) and A_{c}(k), or the digital measurements Aᵣ(k), A_{c}(k), A_{longi}(k), Aₗₐₜ(k), and A_{c}(k) at instant k of the accelerations of the wheel and of the body are determined by filtering and sampling. At 44, a prediction \hat{z}⁻(k) of the state vector z is calculated, then, at 46, an estimation \hat{z}⁻(k) of the state vector z is calculated.

In a subsequent step 48, the estimations \hat{K}_{c}(k), \hat{R}_{c}(k), \hat{F}_{spring}(k) and \hat{F}_{damp}(k) are calculated as a function of the estimation \hat{z}(k) and of the mass m_{c} of the body adjusted to the wheel.

A step 50 of controlling the operation of the vehicle and of diagnosing the operating state of the suspension as a function of the estimations \hat{z}₁(k)=dêb(k), \hat{z}₂(k)=V\hat{d}eb(k), \hat{K}_{c}(k), \hat{R}_{c}(k), \hat{F}_{spring}(k) and \hat{F}_{damp}(k) is then triggered. Step 50 then loops back to step 42 for a new computing cycle.

FIG. 4 is a graph on which have been traced, as a function of time, the clearance estimated by the first embodiment of the system of FIG. 2 and the clearance measured by a sensor. FIG. 5 is a graph on which have been traced, as a function of time, the clearance variation speed estimated by the first embodiment of the system shown on FIG. 2 and the derivative of the clearance measured by a sensor.

As can be observed, the first embodiment of the system according to the invention estimates with precision the variations of the clearance and of the clearance variation speed of the suspension, which are mainly caused by the transmission of the solicitations by the ground to the body of the vehicle through the suspension.

FIG. 6 is a graph on which have been traced, as a function of time, the clearance estimated by the second embodiment of the system shown on FIG. 2, taking into account the load transfer to the wheel of the vehicle and the clearance measured by a sensor.

As can be observed, this second embodiment of the system according to the invention estimates with precision the variations of the clearance and of the clearance variation speed of the suspension caused by the transmission of the solicitations by the ground. This second embodiment also estimates with precision the slow dynamics solicitations. That is, taking into account the load transfers at the wheel makes it possible to estimate the very low frequency movements of the body of the vehicle caused, for example, when the vehicle is braking, accelerating, or turning.

A system for estimating characteristics of a motor vehicle suspension based on a non-linear state representation mechanical model has been described.

As a variant, the system is adapted to estimate the clearance and the clearance variation speed of the suspension by implementing a Kalman estimator based on a discretization of one or the other of the linear state representations according to the following equations (16) and (17), the coefficient of stiffness K_{c}, the damping coefficient R_{c}, and the mass m_{c} of the body adjusted to the wheel being considered constant and of known values:

$$\begin{matrix}\{ \begin{matrix}\dot{x} ( t ) = [ \begin{matrix}0 & 1 \\ - \frac{{K}_{c}}{{m}_{c}} & - \frac{{R}_{c}}{{m}_{c}}\end{matrix} ] x ( t ) + [ \begin{matrix}0 \\ 1\end{matrix} ] u ( t ) \\ y ( t ) = [ \frac{{K}_{c}}{{m}_{c}} \frac{{R}_{c}}{{m}_{c}} ] x ( t )\end{matrix} with \{ \begin{matrix}x ( t ) = [ \begin{matrix}deb ( t ) \\ Vdeb ( t )\end{matrix} ] \\ u ( t ) = {A}_{r} ( t ) \\ y = {A}_{c} ( t )\end{matrix} & ( 16 ) \\ \{ \begin{matrix}\dot{x} ( t ) = [ \begin{matrix}0 & 1 \\ - \frac{{K}_{c}}{{m}_{c}} & - \frac{{R}_{c}}{{m}_{c}}\end{matrix} ] x ( t ) + [ \begin{matrix}0 & 0 & 0 \\ 1 & - α & - β\end{matrix} ] u ( t ) \\ y ( t ) = [ \frac{{K}_{c}}{{m}_{c}} \frac{{R}_{c}}{{m}_{c}} ] x ( t ) + [ 0 α β ] u ( t )\end{matrix} with \{ \begin{matrix}x ( t ) = [ \begin{matrix}deb ( t ) \\ Vdeb ( t )\end{matrix} ] \\ u ( t ) = [ \begin{matrix}{A}_{r} ( t ) \\ {A}_{longi} ( t ) \\ {A}_{lat} ( t )\end{matrix} ] \\ y ( t ) = {A}_{c} ( t )\end{matrix} & ( 17 )\end{matrix}$$

Similarly, a system for estimating characteristics of a motor vehicle suspension has been described.

As a variant, this system can be applied to any number of suspensions. For example, to estimate characteristics of the four suspensions of a vehicle equipped with four wheels, the system includes four pairs of accelerometers, i.e., a pair of accelerometers for measuring the vertical accelerations of the wheel and of the body associated with each suspension in the above-described manner. The system then determines the characteristics of this suspension as a function of the measurements supplied by this pair of accelerometers in the above-described manner.

1. System for estimating at least one characteristic of at least one motor vehicle suspension, the or each suspension connecting a wheel of the motor vehicle to the body of this vehicle, comprising means for acquiring the vertical accelerations of the wheel and of the body in a referential of the vehicle and means for calculating the at least one characteristic of the suspension as a function of the acquired vertical accelerations of the wheel and of the body.

2. System according to claim 1, wherein each of the at least one characteristic is selected from the group consisting of the clearance of the suspension, the clearance variation speed of the suspension, the coefficient of stiffness of the suspension, the damping coefficient of the suspension, the spring force of the suspension, and the damping force of the suspension.

3. System according to claim 1, wherein the means for calculating the at least one characteristic are adapted to calculate this at least one characteristic based on a mono-wheel mechanical model of the wheel connected to the body thereof by means of the suspension.

4. System according to claim 3, wherein the calculation means comprise means forming Kalman estimator adapted to estimate the at least one characteristic from the mono-wheel mechanical model.

5. System according to claim 4, wherein the means forming Kalman estimator are adapted to implement an extended Kalman estimator of the state vector
$${( {z}_{1} {z}_{2} {z}_{3} {z}_{4} )}^{T} = {( deb Vdeb \frac{{K}_{c}}{{m}_{c}} \frac{{R}_{c}}{{m}_{c}} )}^{T} ,$$
where zᵢ, i=1, . . . 4, is a state variable, deb is the clearance, Vdeb is the clearance variation speed, m_{c} is the mass of the vehicle body adjusted to the wheel, K_{c} is the coefficient of stiffness of the suspension, and R_{c} is the damping coefficient of the suspension.

6. System according to claim 4, wherein the means forming Kalman estimator are adapted to estimate the state vector (x₁x₂)^{T}=(deb Vdeb)^{T}, where deb is the clearance of the suspension and Vdeb is the clearance variation speed of the suspension.

7. System according to claim 1, further comprising means for acquiring longitudinal and lateral accelerations of the body, and in that the means for calculating the at least one characteristic are adapted to calculate this at least one characteristic based on a mono-wheel mechanical model of the wheel taking into account load transfers in the area of the wheel.

8. System according to claim 1, wherein the means for acquiring vertical accelerations of the wheel and of the body comprise an accelerometer arranged in the body in vertical alignment with the wheel.

9. System according to claim 1, wherein the vehicle is equipped with four suspensions connecting four wheels to the body of this vehicle, and it comprises, associated with each group composed of a suspension connecting a wheel to the body of the vehicle, accelerometers to measure the vertical accelerations of the wheel and of the body.

10. Method of estimating at least one characteristic of a motor vehicle suspension, the or each suspension connecting a motor vehicle wheel to the body of this vehicle, comprising a step of acquiring the vertical accelerations of the wheel and of the body in a referential of the vehicle, and a step of calculating the at least one characteristic of the suspension as a function of the acquired vertical accelerations of the wheel and of the body.

11. Method according to claim 10, wherein each of the at least one characteristic is selected from the group consisting of the clearance of the suspension, the clearance variation speed of the suspension, the coefficient of stiffness of the suspension, the damping coefficient of the suspension, the spring force of the suspension, and the damping force of the suspension.

12. Method according to claim 10, wherein the step of calculating the at least one characteristic comprise calculating this at least one characteristic based on a mono-wheel mechanical model of the wheel connected to the body thereof by means of the suspension.

13. Method according to claim 12, wherein the calculation step comprises using a Kalman estimator to estimate the at least one characteristic from the mono-wheel mechanical model.

14. Method according to claim 13, wherein the Kalman estimator implements an extended Kalman estimator of the state vector
$${( {z}_{1} {z}_{2} {z}_{3} {z}_{4} )}^{T} = {( deb Vdeb \frac{{K}_{c}}{{m}_{c}} \frac{{R}_{c}}{{m}_{c}} )}^{T} ,$$
where zᵢi=1, . . . 4, is a state variable, deb is the clearance, Vdeb is the clearance variation speed, m_{c} is the mass of the vehicle body adjusted to the wheel, K_{c} is the coefficient of stiffness of the suspension, and R_{c} is the damping coefficient of the suspension.

15. Method according to claim 13, wherein the Kalman estimator estimates the state vector (x₁x₂)^{T}=(deb Vdeb)^{T}, where deb is the clearance of the suspension and Vdeb is the clearance variation speed of the suspension.

16. Method according to claim 10, further comprising a step of acquiring longitudinal and lateral accelerations of the body, and which the step of calculating the at least one characteristic comprises calculate this at least one characteristic based on a mono-wheel mechanical model of the wheel taking into account load transfers in the area of the wheel.

17. Method according to claim 10, wherein the step of acquiring vertical accelerations of the wheel and of the body comprise using an accelerometer arranged in the body in vertical alignment with the wheel.

18. Method according to claim 10, wherein the vehicle is equipped with four suspensions connecting four wheels to the body of this vehicle, and it comprises, associated with each group composed of a suspension connecting a wheel to the body of the vehicle, accelerometers to measure the vertical accelerations of the wheel and of the body.
